(19) United States
(12) Patent Application Publication
(10) Pub. No.: US 2020/0269400 A1
(43) Pub. Date: Aug. 27, 2020

(54) TORQUE DRIVER INTEGRATED WITH A VALVE CORE REMOVAL TOOL

(71) Applicant: Anderson Brass Company, Hartsville, SC (US)

(72) Inventor: ERIC SCOTT JONES, Camden, SC (US)

(21) Appl. No.: 16/793,720

(22) Filed: Feb. 18, 2020

Related U.S. Application Data
(60) Provisional application No. 62/808,473, filed on Feb. 21, 2019.
(60) Provisional application No. 62/959,554, filed on Jan. 10, 2020.

(51) Int. Cl. B25B 23/142; F16K 51/00; B25B 27/24

(52) U.S. Cl. CPC B25B 23/1427; B25B 27/24; F16K 51/00

(57) ABSTRACT

An apparatus includes a tool holder, a knob, and a clutch coupling the tool holder to the knob and including a biasing element disposed between a first detent button and a second detent button. The knob defines an internal surface with an engaging surface disposed facing the tool holder and defining a first wedge-shaped protuberance that includes a first stop surface and a first ramp surface. The distal ramp surface is disposed contacting one of the first detent button and the second detent button when the knob rotates in the first rotational direction about the central longitudinal axis. The distal stop surface is disposed to contact one of the first detent button and the second detent button when the knob plate rotates in the second rotational direction about the central longitudinal axis.

### CROSS-REFERENCE TO RELATED APPLICATIONS

This application claims priority to US provisional patent application serial no. 62-808,473 filed on Feb. 21, 12019, which is hereby incorporated herein by this reference for all purposes. This application claims priority to US provisional patent application serial no. 62-959,554 filed on Jan. 10, 2020, which is hereby incorporated herein by this reference for all purposes.

### STATEMENT REGARDING FEDERALLY SPONSORED RESEARCH OR DEVELOPMENT

Not applicable.

### FIELD OF THE INVENTION

The subject matter disclosed herein generally involves apparatus for removing and installing a valve core from a sealed system that is not at atmospheric pressure.

### BACKGROUND OF THE INVENTION

HVAC units that are charged with environmentally harmful refrigerants are maintained at pressures that differ from the atmospheric pressure that surrounds the HVAC unit. These HVAC units are fitted with valves that include valve cores that periodically must be replaced while preventing leakage of the harmful refrigerants from the HVAC unit into the surrounding atmosphere.

Various apparatus and methods for replacing the valve cores in these HVAC units heretofore have been used. U.S. Pat. No. 6,253,436 to Barjesteh, which is hereby incorporated herein by this reference for all purposes, discloses one example of a tool for removing a valve core from a pressurized system. U.S. Pat. No. 7,559,245 to Knowles et al, which is hereby incorporated herein by this reference for all purposes, also discloses an example of a tool for removing a valve core from a pressurized system. However, unless a skilled operator is manipulating these tools to install the valve core with the appropriate amount of torque, too little torque allows refrigerant to leak from the system, while too much torque damages the threads of the valve, which then must be replaced once the valve core fails and needs to be removed.

U.S. Pat. No. 9,199,364 to Ito, which is hereby incorporated herein by this reference for all purposes, discloses another example of a tool for removing a valve core from a pressurized system. This tool includes a torque limiter section that triggers ejection of a marking fluid upon attaining the preset torque value. But this tool fails to alleviate the issues noted above.

U.S. Pat. No. 10,478,953 to Green, which is hereby incorporated herein by this reference for all purposes, discloses still another example of a tool for removing a valve core from a pressurized system. Yet this tool also fails to alleviate the issues noted above.

Due to the variety of different configurations for such valve core structures, the valve removal tool must be configured so as to accommodate such different valve core structures in a way that secures against leaks of the refrigerant into the environment. Having personnel on hand who are sufficiently competent to manipulate the valve removal tool with just the appropriate amount of torque also poses problems. Less competent personnel take longer to engage and remove the defective valve core and install the replacement valve core. Such delays add additional cost to the performance of these tasks. However, until this secure placement has been effected, workers should not be permitted access to the HVAC system. Accordingly, a need exists for apparatus that addresses these issues.

### BRIEF DESCRIPTION OF THE DRAWINGS

Aspects and advantages of the invention are set forth below in the following description, or may be obvious from the description, or may be learned through practice of embodiments of the invention. Those of ordinary skill in the art will better appreciate the features and aspects of such embodiments, and others, upon review of the specification. A full and enabling disclosure of the present invention, including the best mode thereof to one skilled in the art, is set forth more particularly in this specification, including reference to the accompanying figures, in which:

FIG. 1 is an elevated perspective view of an embodiment of the present invention disposed for operation to remove a valve core and looking from the end of a valve removal apparatus configured to be connected to the valve from which the valve core is to be removed and/or installed.

FIG. 2 is a cross-sectional view taken along the longitudinal axis in the direction indicated by the arrows designated 2-2 of the alternative embodiment of FIG. 1.

FIG. 3 is a side elevation view of an alternative embodiment of the present invention attached to a tool and a valve core before installation into a pressure lock apparatus shown in FIGS. 1 and 2.

FIG. 4 is a side elevation view of an embodiment of the present invention.

FIG. 5 is an elevated perspective view of the presently preferred embodiment of FIG. 4 in a dis-assembled state.

FIG. 6 is a side elevation view of FIG. 5 rotated 90 degrees and partially cut away to expose internal features that otherwise would be shielded from view during normal assembly of the embodiment.

FIG. 7 is a side elevation view of the embodiment of FIGS. 4, 5 and 6 in an assembled state and partially cut away to expose internal features that otherwise would be shielded from view during normal assembly of the embodiment.

FIG. 8 is an elevated perspective view of the embodiment of FIG. 7 in an assembled state and partially cut away to expose internal features that otherwise would be shielded from view during normal assembly of the embodiment.

FIG. 9 is a cross-sectional view taken along the diametric axis in the direction indicated by the arrows designated 9-9 of the view of FIG. 4.

FIG. 10 is an elevated perspective view, which is partially cut away to expose internal elements that otherwise would be shielded from view during normal operation, of an alternative embodiment of the present invention shown in FIGS. 1, 2, 3, 11 and 17.

FIG. 11 is an elevated perspective view of an embodiment of the present invention shown in FIG. 12, but with the internal elements shown in a disassembled sequence.

FIG. 12 is an elevated perspective view of an embodiment of the present invention shown in FIG. 10, but with the internal elements shown in a disassembled sequence from the opposite perspective to the perspective of FIG. 11.

FIG. 13 is a cross-sectional view taken along the longitudinal axis in the direction indicated by the arrows designated 2-2 of select components of the embodiment of FIG. 1.

FIG. 14 is an elevated perspective view of the components shown in FIG. 13.

FIG. 15 is an elevated perspective view as in FIG. 12 of select components of the embodiment of FIG. 12.

FIG. 16 is an elevated perspective view as in FIG. 12 of select components of the embodiment of FIG. 12.

FIG. 17 is an elevated perspective view as in FIG. 11 of select components of the embodiment of FIG. 11.

FIG. 18 is an elevated perspective view of an embodiment of one of the components shown in FIGS. 2, 10 and 11.

The accompanying drawings, which are incorporated in and constitute a part of this specification, illustrate at least one presently preferred embodiment of the invention as well as some alternative embodiments. These drawings, together with the written description, explain the principles of the invention but by no means are intended to be exhaustive of every possible embodiment of the invention.

### DETAILED DESCRIPTION OF EXEMPLARY EMBODIMENTS OF THE INVENTION

Reference will now be made in detail to present exemplary embodiments of the invention, wherein one or more examples of which are illustrated in the accompanying drawings. The detailed description uses numerical and/or letter designations to refer to features in the drawings. Like or similar designations in the drawings and description have been used to refer to like or similar parts of the embodiments of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

It is to be understood that the ranges and limits mentioned herein include all sub-ranges located within the prescribed limits, inclusive of the limits themselves unless otherwise stated. For instance, a range from 100 to 1200 also includes all possible sub-ranges, examples of which are from 100 to 150, 170 to 190, 153 to 162, 145.3 to 149.6, and 187 to 1200. Further, a limit of up to 7 also includes a limit of up to 5, up to 3, and up to 4.5, as well as all sub-ranges within the limit, such as from about 0 to 5, which includes 0 and includes 5 and from 5.2 to 7, which includes 5.2 and includes 7.

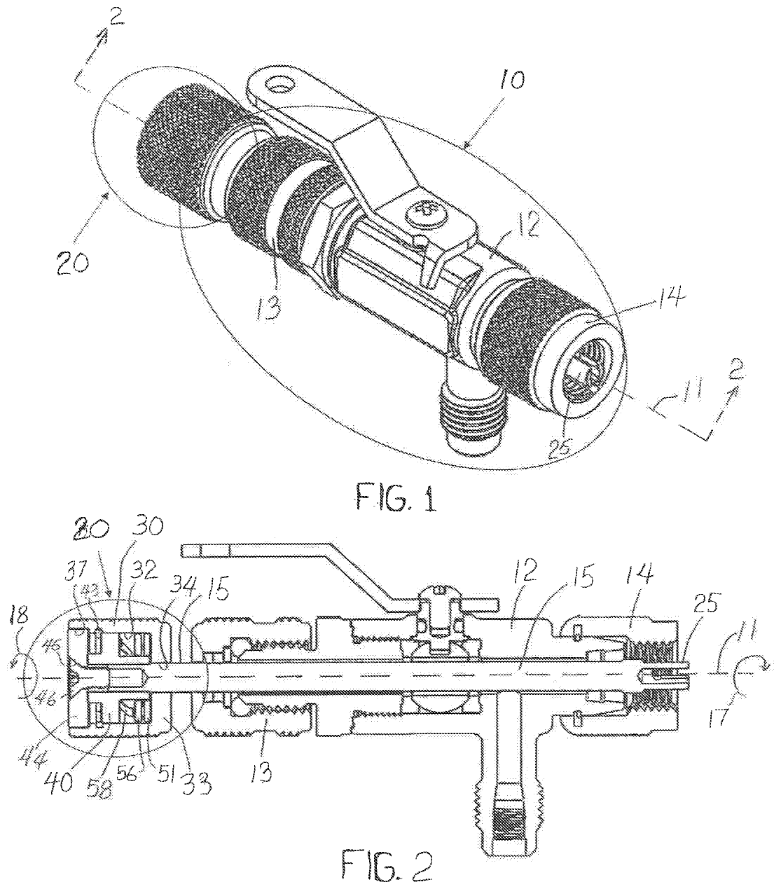

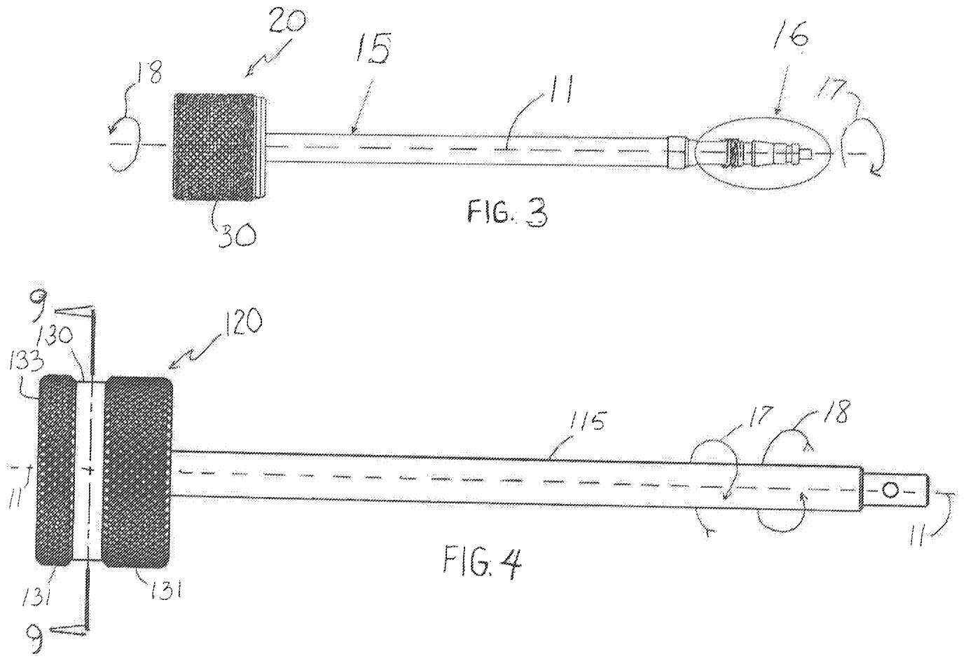

FIG. 1 is an elevated perspective view of an embodiment of a valve removal apparatus 10 and a torque driver 20 of the present invention. FIG. 2 is a cross-sectional view taken along the central longitudinal axis 11 of the embodiment of FIG. 1. As shown in FIGS. 1 and 2, the valve removal apparatus 10 includes a pressure lock 12, which is configured to isolate the HVAC system (not shown) when a valve core 16 (FIG. 3) is removed from the valve seat (not shown). The valve removal apparatus 10 includes a pressure fitting 13 that screws onto the proximal end of the pressure lock 12. The valve removal apparatus 10 includes a coupling fitting 14 that is connected onto the distal end of the pressure lock 12. The valve removal apparatus 10 includes an insertion shaft 15, which is a tool that is used to screw a valve core 16 (FIG. 3) into an HVAC valve (not shown) or alternately unscrew the valve core 16 from the HVAC valve. The insertion shaft 15 desirably is formed in a conventional manner as a rigid rod, which typically is made of steel, and elongates along a central longitudinal axis 11 thereof. The insertion shaft 15 passes successively through the pressure fitting 13, the pressure lock 12 and the coupling fitting 14, which is internally threaded to be screwed onto the exterior threaded surface of the HVAC valve (not shown) that includes the valve seat in which a valve core 16 is to be installed or removed, as required during maintenance of the HVAC system.

FIG. 3 is a side elevation of an alternative embodiment of a torque driver 20 of the present invention connected to the proximal end of an insertion shaft 15. As shown in FIG. 3, a valve core 16 is connected by any conventional means to the distal end of the insertion shaft 15. Because the valve core 16 is non-rotatably attached to the distal end of the insertion shaft 15, rotation of the insertion shaft 15 about its central longitudinal axis 11 effects commensurate rotation of the valve core 16. Thus, rotation of the insertion shaft 15 of the tool in the clockwise direction indicated by the arrow designated by the numeral 17 in FIG. 3 will screw the valve core 16 into the valve seat (not shown) of the HVAC valve (not shown). Conversely, rotation of the insertion shaft 15 of the tool in the counterclockwise direction indicated by the arrow designated by the numeral 18 in FIG. 3 will unscrew the valve core 16 from the valve seat of the HVAC valve. As described more fully below, the configuration of each embodiment of the torque driver of the present invention imposes an upper limit on the magnitude of the torque that the operator can transmit to the valve core 16 and accordingly ensures that the valve core 16 will not become over-tightened to the point of damaging the threads of either the valve core 16 or the mating valve seat when the operator is screwing the valve core 16 in the clockwise direction 17 into the valve seat of the HVAC valve. Moreover, the configuration of each embodiment of the torque driver of the present invention nonetheless allows the operator to transmit sufficient torque to unscrew the valve core 16 in the counterclockwise direction 13 from the valve seat of the HVAC valve, even if the required torque to unscrew the valve core 16 is greater than the upper limit imposed in the clockwise direction 17.

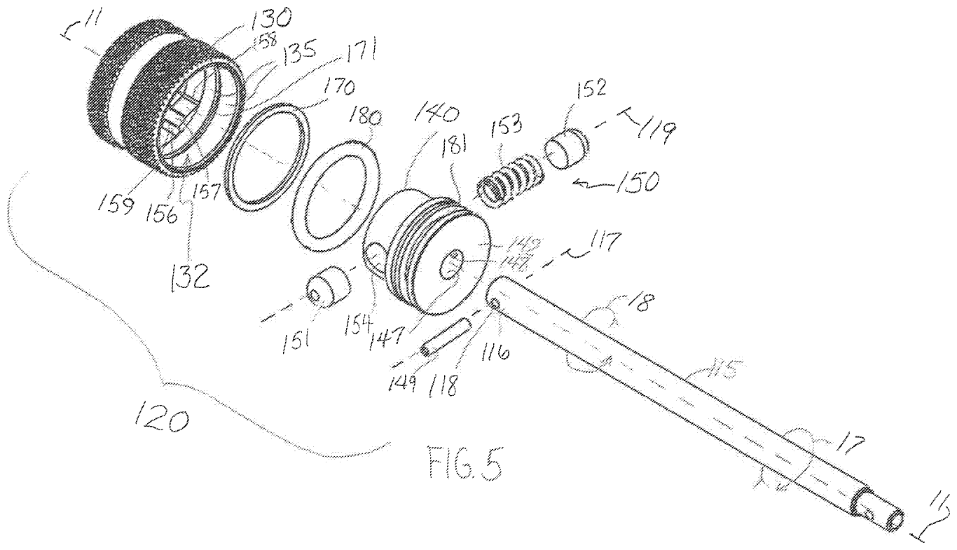

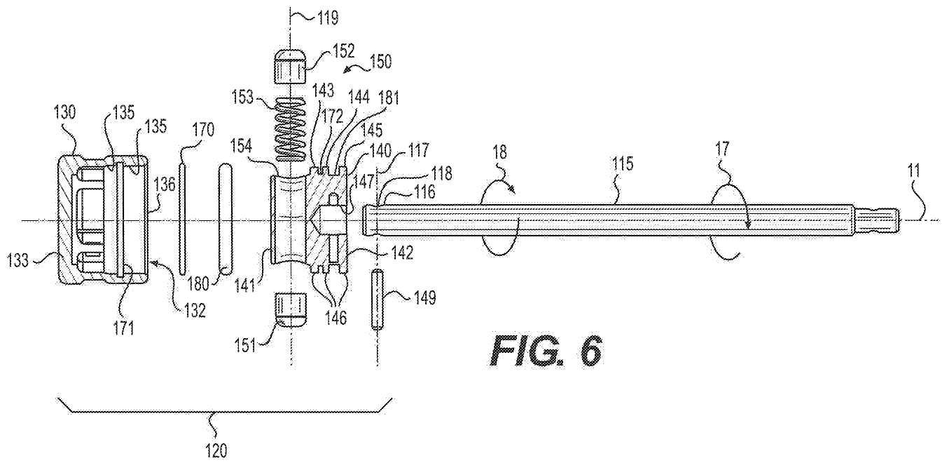

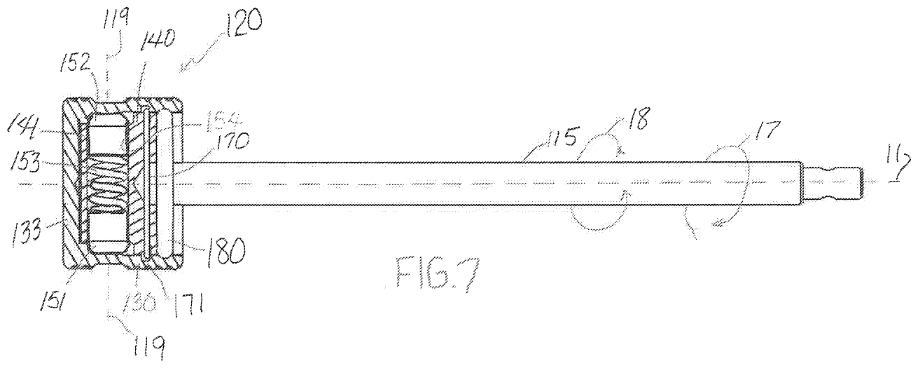

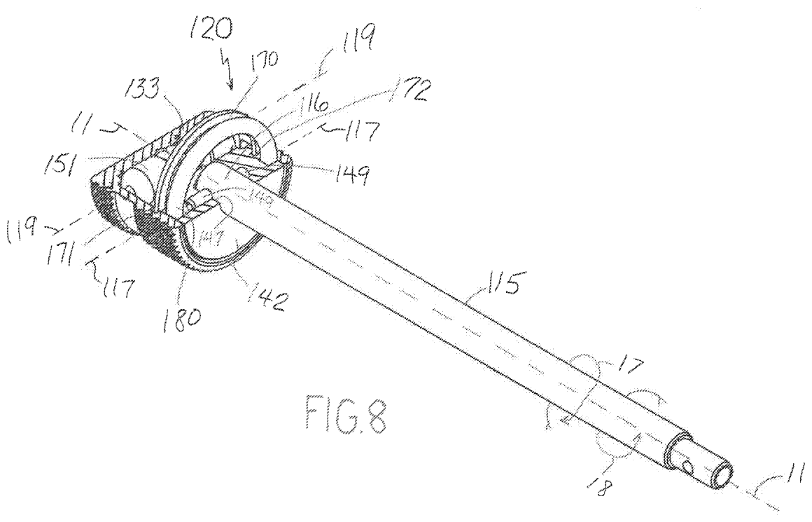

FIG. 4 shows a side elevation view of a presently preferred embodiment of a torque driver 120 for driving an insertion shaft 115 for selectively installing and removing a valve core 16 (FIG. 3) from a valve seat of a valve in a pressurized system, such as HVAC system. Other views of the torque driver 120 and/or insertion shaft 115 are shown in FIG. 5. FIG. 6, FIG. 7, FIG. 8 and FIG. 9. As schematically shown in the disassembled views of FIG. 5 and FIG. 6 for example, a presently preferred embodiment of the torque driver 120 includes a knob 130, a tool holder 140 and a clutch 150 that couples the tool holder 140 to the knob 130. As described below, the clutch 150 is configured to limit the maximum torque that can be transmitted by the knob 130 to the tool holder 140 when the knob 130 is rotated in the clockwise direction 17 about the central longitudinal axis 11 without limiting the torque transmitted to the tool holder 140 via the knob 130 when the knob 130 is rotated in the counterclockwise direction 18 about the central longitudinal axis 11.

As shown in FIG. 4 for example, the knob 130 provides an external gripping surface 131 by which the user can manually rotate the torque driver 120. The knob 130 functions as a housing for the components that form embodiments of the tool holder 140 and the clutch 150. The knob 130 desirably is formed of strong rigid material such as steel, bronze or other metal. The knob 130 desirably could be formed of hard plastic material such as polycarbonate or formed of a resinous matrix of carbon fiber or fiberglass. As schematically shown in the disassembled views of FIG. 5 and FIG. 6 for example, an embodiment of a knob 130 desirably is formed as a hollow cylindrical member that is generally cylindrically shaped about a central longitudinal axis 11 that elongates along the axial direction and coincides with the central longitudinal axis 11 of the insertion shaft 115.

As shown in FIG. 6 for example, the knob 130 defines a proximal end and a distal end spaced apart in an axial direction along the central longitudinal axis 11 from the proximal end. As shown in FIG. 6 and FIG. 7 for example, the proximal end of the knob 130 includes a proximal web 133 that extends diametrically and completely closes off the proximal end of the knob 130. As shown in FIG. 6 for example, a presently preferred embodiment of the knob 130 defines an entrance opening 136 at the distal end of the knob 130. As shown in FIG. 5 and FIG. 6 for example, the knob 130 defines an internal surface 132, which defines a passage extending in an axial direction from the entrance opening 136 at the distal end of the knob 130 to the proximal web 133 at the proximal end of the knob 130. The internal surface 132 is generally cylindrically shaped about the central longitudinal axis 11 that elongates along the axial direction.

As shown in FIG. 6, the tool holder 140 defines a proximal end 141 and a distal end 142 spaced apart in the axial direction from the proximal end 141. The tool holder 140 includes a cylindrical body that elongates about the central longitudinal axis 11 in the axial direction between the proximal end 141 and the distal end 142. As shown in the disassembled views of FIG. 5 and FIG. 6, a presently preferred embodiment of a tool holder 140 is configured to be rotatably disposed within the passage defined by the internal surface 132 of the knob 130. As shown in FIG. 5 and FIG. 6, sections of the internal surface 132 of the knob 130 define bearing surfaces 135. As shown in FIG. 6 for example, an embodiment of the tool holder 140 includes three annular webs 143, 144, 145 extending circumferentially around the tool holder 140. As shown in FIG. 6, a proximal annular web 143 is spaced apart axially from an intermediate annular web 144, which is also spaced apart axially from a distal annular web 145. As schematically shown in FIG. 6, each of the outermost circumferentially extending edges of the three annular webs 143, 144, 145 of the tool holder 140 defines an edge surface 146 that is configured to freely rotate about the central axis 11 with respect to the opposing bearing surface 135 of the internal surface 132 of the knob 130 and accordingly permits the tool holder 140 to rotate freely within the bearing surface 135 that is defined by sections of the internal surface 132 of the knob 130.

As schematically shown in FIG. 7, the proximal end 141 of the tool holder 140 is disposed at the proximal end of the knob 130 in opposition to the proximal web 133 of the knob 130 when the tool holder 140 is inserted through the entrance opening 136 at the distal end of the knob 130 and disposed within the passage of the knob 130. The tool holder 140 is configured to permit the insertion shaft 115 of the valve removal tool 10 to slide into the tool holder 140 along the axial direction. As shown in FIG. 5 and FIG. 6, a presently preferred embodiment of the tool holder 140 defines a tool recess 147 through the distal end 142 of the tool holder 140. The tool recess 147 extends in the axial direction about the central longitudinal axis 11 and thus along the longitudinal axis 11 of rotation of the tool holder 140. The tool recess 147 extends from the recess opening toward the proximal end 141 of the tool holder 140 and is configured to slidably receive therein a proximal section 116 of the insertion shaft 115. The depth of the tool recess 147 is defined desirably by a blind end that desirably is disposed axially about halfway into the interior of the tool holder 140.

The tool holder 140 is configured to become non-rotatably coupled to the insertion shaft 115 of the tool 10 so that the tool holder 140 and the insertion shaft 115 rotate together as a unitary structure. As shown in FIG. 6, the tool holder 140 defines a pin passage 148 that extends in a transverse direction that is parallel to a transverse axis 117 that is normal to the axial direction 11. The pin passage 148 elongates sufficiently to pass through the tool recess 147. As shown in FIG. 5, the proximal section 116 of the insertion shaft 115 is provided with a side bore 118 that extends diametrically through the proximal section 116 of the insertion shaft 115. The diameter of the side bore 118 is commensurate with the diameter of the pin passage 148. As shown in FIG. 5, FIG. 6 and FIG. 8, the tool holder 140 includes a pin 149 connecting the proximal end 116 of the insertion shaft 115 and the tool holder 140. As shown schematically in the cut-away partial cross-sectional view of FIG. 8, when the proximal section 116 of the insertion shaft 115 is received within the tool recess 147, the pin 149 extends through the aligned pin passage 148 of the tool holder 140 and the side bore 118 of the proximal section 116 of the insertion shaft 115. In this way, the pin 149 non-rotatably couples the insertion shaft 115 of the tool 10 to the tool holder 140. Assembled as schematically shown in FIG. 8, the rotation of the tool holder 140 effects commensurate rotation of the insertion shaft 115 in the same direction, whether clockwise 17 or counterclockwise 18. The tool holder 140, including the pin 149, desirably is formed of strong rigid material such as steel, bronze or other metal. The tool holder 140 desirably could be formed of hard plastic material such as polycarbonate or formed of a resinous matrix of carbon fiber or fiberglass.

As noted above, a clutch 150 couples the tool holder 140 to the knob 130 while being configured to limit the maximum torque that can be applied to the tool holder 140 via the knob 130 in a first rotational direction, which desirably is the clockwise direction 17, without limiting the torque that can be applied to the tool holder 140 via the knob 130 in a second rotational direction that is opposite to the first rotational direction. As schematically shown in FIG. 5, FIG. 6 and FIG. 9, the tool holder 140 defines a clutch passage 154 that extends diametrically through the cylindrical body of the tool holder 140 in a direction that is along a transverse axis 119. As schematically shown in FIG. 5, FIG. 6 and FIG. 7, the transverse axis 119 extends in a direction that is normal to the axial direction along the central longitudinal axis 11.

In accordance with the present invention, as shown in FIG. 5, FIG. 6, FIG. 7 and FIG. 9 for example, a presently preferred embodiment of a clutch 150 includes a first detent button 151, a second detent button 152 and a resilient biasing member such as a spring 153 disposed between the first detent button 151 and the second detent button 152. As embodied herein and shown in FIG. 5 and FIG. 9, a traditional wound spring 153 desirably serves as a suitable biasing member to exert a biasing force in the transverse direction along the transverse axis 119. However, the biasing member can be, but is not limited to, a wave spring, a Belleville spring, or an object made out of a compressible material such as an O-ring, which can be made out of a variety of different compounds and profiles to obtain the desired compressibility and spring force.

As shown in FIG. 7 and FIG. 9 for example, the first detent button 151, the second detent button 152 and the spring 153 are disposed in the clutch passage 154. Each detent button 151, 152 desirably is identically shaped as a generally cylindrical member with two opposite ends. As shown in FIG. 9 for example, each detent button 151, 152 desirably is a solid member and desirably is formed of strong rigid material such as brass, bronze, tungsten or stainless steel. Each detent button 151, 152 desirably could be formed of hard plastic material such as polycarbonate or formed of a resinous matrix of carbon fiber or fiberglass. As shown in FIG. 9 for example, one of the opposite ends of each detent button 151, 152 contacts one of the opposite ends of the spring 153. As schematically shown in FIG. 9 for example, the other of the opposite ends of each detent button 151, 152 engages the internal surface 132 of the knob 130.

As shown in FIG. 5 and FIG. 9 for example, the internal surface 132 of the knob 130 defines a first engaging surface that includes a wedge-shaped protuberance 155. As shown in FIG. 9 for example, each wedge-shaped protuberance 155 is defined by a stop surface 156 and a ramp surface 157. As shown in FIG. 5 and FIG. 9 for example, the stop surface 156 is a flat planar surface, and the ramp surface 157 is gradually inclining from a lowest point 158 to a vertex 159. The stop surface 156 desirably is contiguous to the ramp surface 157 at the vertex 159 of the wedge-shaped protuberance 155. The radial distance measured from the longitudinal centerline 11 to the vertex 159 is the minimum radial distance between the internal surface 132 of the knob 130 and the longitudinal centerline 11. Each of the wedge-shaped protuberances 155 desirably can be formed in a machining operation applied to the internal surface 132 of the knob 130.

In the embodiment shown in FIG. 5 and FIG. 9 for example, there is a plurality of wedge-shaped protuberances 155 and indeed a first, second, third and fourth wedge-shaped protuberance 155. The wedge-shaped protuberances 155 are evenly and symmetrically spaced apart circumferentially from one another on the internal surface 132 of the knob 130. Depending on the size and shape of the wedge-shaped protuberances 155, the number of wedge-shaped protuberances 155 in the plurality can be fewer or greater than four. A single wedge-shaped protuberance 155 could suffice provided the ramp surface 157 extends around essentially most of the entirety of the circumference of the internal surface 132 of the knob 130.

The knob 130 and the tool holder 140 will rotate as a unitary structure until the frictional forces between the buttons 151, 152, and the internal surface 132 of the knob 130 are exceeded by the torque that is being applied to the knob 130 to rotate the knob 130. Moreover, the magnitude of the frictional forces between the buttons 151, 152 and the internal surface 132 of the knob 130 is directly proportional to the biasing force applied by the spring 153. Thus, taking into account the relative surface areas that are in contact between the buttons 151, 152 and the internal surface 132, the coefficients of static friction and dynamic friction and the force constant of the spring 153, it becomes possible to predetermine the torque limit of the torque driver 120.

As schematically shown in FIG. 9, the knob 130 is rotated into a neutral position with respect to the detent buttons 151, 152 so that each of the detent buttons 151, 152 is disposed at a trough section 160 of the internal surface 132 of the knob 130. The radial distance measured from the longitudinal centerline 11 to the trough surface 160 is the maximum radial distance between the internal surface 132 of the knob 130 and the longitudinal centerline 11. A trough section 160 is disposed between the stop surface 156 of one wedge-shaped protuberance 155 and the ramp surface 157 of the next adjacent wedge-shaped protuberance 155. In the embodiment shown, there are two possible neutral positions. In a neutral position schematically shown in FIG. 9, the biasing force exerted by the spring 153 ensures the maximum separation between the detent buttons 151, 152 engaged in respective trough sections 160 of the internal surface 132 of the knob 130.

Referring to FIG. 9, rotation of the knob 130 in the clockwise direction 17 from the neutral position will cause the ramp surface 157 of one wedge-shaped protuberance 155 to engage with the first detent button 151 and the ramp surface 157 of another wedge-shaped protuberance 155 to engage with the second detent button 152.

Conversely, rotation of the knob 130 in the counterclockwise direction 18 from the neutral position will cause the stop surface 156 of one wedge-shaped protuberance 155 to engage with the first detent button 151 and the stop surface 156 of another wedge-shaped protuberance 155 to engage with the second detent button 152.

The clutch 150 operates on the principle of balancing the torque needed to screw the valve core 16 into the valve seat of the HVAC valve against the friction generated between the detent buttons 151, 152 and the internal surface 132 of the knob 130. The clutch 150 includes a biasing element that is configured and disposed to urge the detent buttons 151, 152 against the internal surface 132 of the knob 130 with a force that is predetermined according to a maximum torque for rotating the valve core 16 into the valve seat. As embodied herein and shown in FIG. 9, a biasing element 153 desirably includes a spring disposed between the detent buttons 151, 152 and configured to exert a biasing force in the transverse direction along the transverse axis 119.

The resilient force constant (a.k.a. the spring constant) of the biasing member 153 and the distance the biasing member 153 is compressed axially in the assembly of the torque driver 120, and the resulting biasing force that is generated as the buttons 151, 152 reach the vertices 159 of the engaged ramp surfaces 157 of the wedge-shaped protuberances 155, will determine the threshold torque at which the knob 130 slips, i.e., rotates in the clockwise direction 17 independently of the tool holder 140. This is the threshold torque and is the design torque that is to be attained when the valve core 16 will be installed in the valve seat in a manner that ensures against leakage but without damaging the threads of either the valve seat or the valve core 16. When the magnitude of the circumferentially directed frictional force between the buttons 151, 152 and the internal surface 132 of the knob 130 caused by the biasing member 153 remains below the threshold design torque, then when the knob 130 rotates in the clockwise direction 17 under these conditions, the trough surfaces 160 or the ramp surfaces 157 are disposed contacting the buttons 151, 152 without any slippage between the buttons 151, 152 and the internal surface 132 of the knob 130. In other words, the frictional forces between the buttons 151, 152 and the internal surface 132 of the knob 130 suffice to prevent relative movement between the tool holder 140 and the knob 130 when the user exerts torque on the knob 130 of the torque driver 120 in the clockwise direction 17 as shown in FIG. 9 for example. Moreover, the axial force exerted by the biasing member 153 is always of sufficient magnitude to ensure that the stop surfaces 156 are disposed contacting the buttons 151, 152 when the knob 130 rotates in the counterclockwise direction 18 schematically shown in FIG. 9.

The torque driver 120 of the present invention is configured to enable the user to apply sufficient axially directed pressure with the insertion shaft 115 of the tool 10 so as to be able to engage the valve core 16 with the insertion shaft 115 so that the torque driver 120 can be used to rotate the insertion shaft 115 and then engage the valve core 16 with respect to the valve seat of the HVAC valve. As embodied herein, the torque driver 120 desirably includes a bulkhead element that resists against movement of the tool holder 140 in the axial direction toward the proximal end 133 of the knob 130. As embodied herein and shown in FIGs. B and D for example, the torque driver 120 includes a bulkhead element that includes a ring 170. As shown in FIG. 5 for example, the internal surface 132 of the knob 130 defines an inner slot 171 that extends circumferentially about the central longitudinal axis 11. As shown in FIG. 6, the distal half of the tool holder 140 defines an outer slot 172 that extends circumferentially about the central longitudinal axis 11. The outer slot 172 is defined between the proximal annular web 143 and the intermediate annular web 144 of the tool holder 140. As shown in FIG. 7, the outer slot 172 is disposed opposite the inner slot 171 of the assembled torque driver 120. As schematically shown in the partially cut away view of FIG. 8, the ring 170 is received in both the inner slot 171 and the outer slot 172 and configured to restrain movement of the tool holder 140 in the axial direction relative to the knob 130 along the central longitudinal axis 11. The bulkhead element desirably includes a snap spring 170. Thus, the snap spring 170 absorbs any axial force resulting from the axially directed pressure that is needed in order to maintain the distal end of the insertion shaft 115 engaged with the valve core 16 for purposes of rotating the valve core 16 with respect to the valve seat. Additionally, the snap spring 170 connects the tool holder 140 to the knob 130 and prevents relative movement between them along the central longitudinal axis 11.

As embodied herein and shown in FIG. 5 and FIG. 6 for example, the torque driver 120 desirably includes a sealing element that includes a resiliently deformable O-ring 180. As shown in FIG. 6 for example, the tool holder 140 defines an outer groove 181 that extends circumferentially about the central longitudinal axis 11. As shown in FIG. 6, the outer groove 181 is defined between the intermediate annular web 144 and the distal annular web 145 of the tool holder 140. When the torque driver 120 is assembled, the outer groove 181 of the tool holder 140 will be disposed opposite the bearing surfaces 135 of the knob 130 near the entrance opening 136 of the knob 130. When the torque driver 120 is assembled, the O-ring 180 is received in the outer groove 181 and configured to seal against the bearing surfaces 135 of the knob 130 and accordingly seal the passage of the knob 130.

A presently preferred embodiment of a torque driver 120 includes an insertion shaft 115 that is permanently attached to the tool holder 140. As schematically shown in FIG. 5 and FIG. 6 for example, the user begins assembling the torque driver 120 by inserting the proximal end 116 of the insertion shaft 115 into the tool recess 147 in the distal end of tool holder 140 and aligning the side bore 118 with the pin passage 148. The pin 149 is inserted into the pin passage 148 and through the side bore 118 to secure the insertion shaft 115 non-rotatably to the tool holder 140. The O-ring 180 is disposed into the outer groove 181 in tool holder 140, and the snap ring 170 is disposed into the outer slot 172 in distal end 142 of tool holder 140. The user then slides the biasing member 153 into the clutch passage 154 in the tool holder 140. The first detent button 151 is inserted into the clutch passage 154 and rests against one end of the biasing member 153. The second detent button 152 is inserted into the clutch passage 154 and rests against the other end of the biasing member 153. The resulting sub-assembly that includes the insertion shaft 115 attached to the tool holder 140 is then inserted axially through entrance opening 136 at the distal end of the knob 130 and into the passage defined by the internal surface 132 of the knob until the proximal end 141 of the tool holder 140 opposes the inner surface of the proximal web 133 of the knob and the snap ring 170 snaps into the inner slot 171 in the internal surface 132 of the knob 130. The torque driver 120 is now fully assembled as shown in FIG. 4 and ready for use. The user then can attach a valve core 16 onto the gripper 25 at the distal end of the insertion shaft 115 of the insertion tool 120 in the manner similar to what is shown in FIG. 3 for example. The valve removal apparatus 10 is then outfitted to install a replacement valve core 16 into the valve seat of an HVAC valve (not shown).

The user attaches the coupling fitting 14 to the proximal end of the HVAC valve (not shown). Once the valve core 16 reaches the valve seat (not shown), then the user's rotation of the torque driver 120 in the clockwise direction 17 about the longitudinal axis 11 is effected by clockwise rotation of the knob 130. This rotation of the knob 130 in the clockwise direction 17 effects a commensurate clockwise rotation of the insertion shaft 115 of the insertion tool and accordingly effects a clockwise rotation of the valve core 16. This clockwise rotation of the valve core 16 screws the valve core 16 into the valve seat.

However, once the design torque between the valve core 16 and the valve seat has been attained, then the operation of the clutch 150 prevents any further rotation of the knob 130 from further rotating the insertion shaft 115 and the attached valve core 16. The torque driver 120 can be provided with different design torques by the mere substitution of different biasing members 153 having different resilient force constants that are attuned to the desired maximum design torque that is appropriate to the valve core 16 and valve seat in question.

Removal of a valve core 16 means that the coupling fitting 14 of the valve removal apparatus 10 is connected to the proximal end of the HVAC valve (not shown) when the distal end of the insertion shaft 115 with the gripper 25 is extending out of the coupling fitting 14 without any valve core 16 connected to the gripper 25. The user moves the knob 130 axially until the gripper 25 non-rotatably secures the valve core 16. The user than rotates the knob 130 and the insertion shaft 115 and valve core 16 in the counterclockwise direction 18 to unscrew the valve core 16 from the valve seat of the HVAC valve. However, in accordance with the torque driver 120 of the present invention, the clutch 150 is not operative during rotation of the knob 130 in the counterclockwise direction 18, and thus the torque driver 120 of the present invention can be used to remove a valve core 16 by rotation of the knob 130 in the counterclockwise direction 18 even if the torque required for removal exceeds the design torque of the clutch 150.

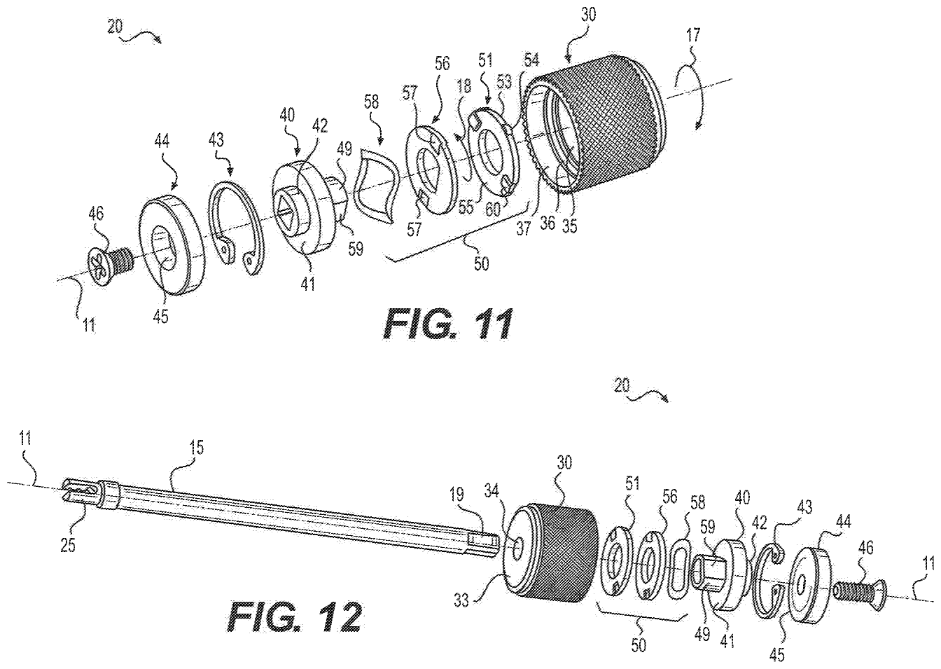

An alternative embodiment of a torque driver for driving a tool 15 for selectively installing and removing a valve core 16 from a valve seat of a valve in a pressurized system, such as an HVAC system, is schematically shown in FIGS. 11 and 12 for example, and includes a torque driver 20 includes a knob 30, a tool holder 40 and a clutch 50. The clutch 50 couples the tool holder 40 to the knob 30 while being configured to limit the maximum torque that can be transmitted by the knob 30 to the tool holder 40 when the knob 30 is rotated in the clockwise direction 17 about the central longitudinal axis 11 without limiting the torque transmitted to the tool holder 40 via the knob 30 when the knob 30 is rotated in the counterclockwise direction 18 about the central longitudinal axis 11.

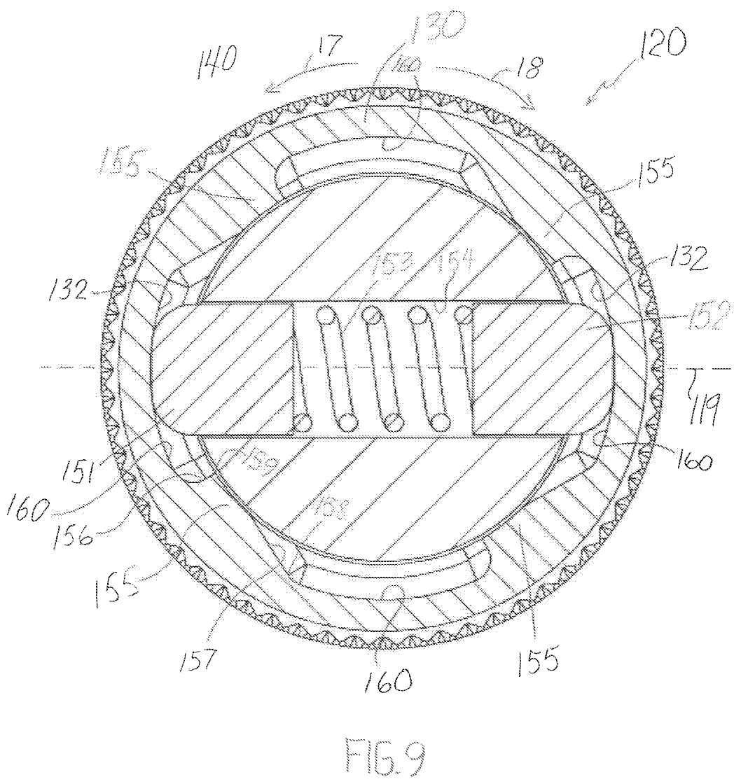

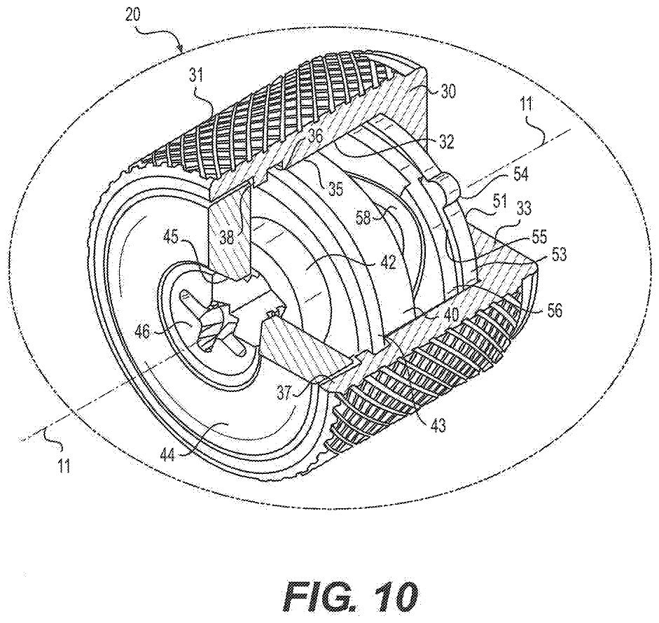

As shown in FIG. 10 for example, the knob 30 provides an external gripping surface 31 by which the user can manually rotate the torque driver 20. The knob 30 functions as a housing for the components that form embodiments of the tool holder 40 and the clutch 50. The knob 30 desirably is formed of strong rigid material such as steel, bronze or other metal. The knob 30 desirably could be formed of hard plastic material such as polycarbonate or formed of a resinous matrix of carbon fiber or fiberglass. As shown in FIGS. 10 and 11 for example, an embodiment of a knob 30 desirably is formed as a hollow cylindrical member that is generally cylindrically shaped about a central longitudinal axis 11 that elongates along the axial direction and coincides with the central longitudinal axis 11 of the insertion shaft 15 shown in FIGS. 2 and 3 for example.

As shown in FIGS. 2 and 10 for example, the knob 30 defines an internal surface 32, which defines a passage extending in an axial direction through the knob 30. As shown in FIGS. 2, 10 and 12 for example, a distal end of the knob 30 includes a distal web 33 that extends diametrically from the internal surface 32 toward the central axis 11 of the knob 30 and partially closes off the distal end of the knob 30. As shown in FIGS. 2 and 12 for example, the distal web 33 defines an aperture 34 surrounding the central axis 11, and the aperture 34 is configured to permit passage of the insertion shaft 15 of the insertion tool through the aperture 34.

As shown in FIGS. 2 and 11, an embodiment of a tool holder 40 is configured to be rotatabiy disposed within the passage defined by the internal surface 32 of the knob 30. As shown in FIGS. 10 and 11, a section of the internal surface 32 of the knob 30 defines a bearing surface 35. As shown in FIGS. 11, 13 and 14 for example, an embodiment of the tool holder 40 includes an annular disc forming a journal portion 41. As shown in FIGS. 13, 14 and 15, the outermost circumferentiaily extending edge of the journal portion 41 of the tool holder 40 defines an edge surface 47 that is configured to freely rotate with respect to the bearing surface 35 of the internal surface 32 of the knob 30 and accordingly permits the tool holder 40 to rotate freely within the bearing surface 35 that is defined by a section of the internal surface 32 of the knob 30.

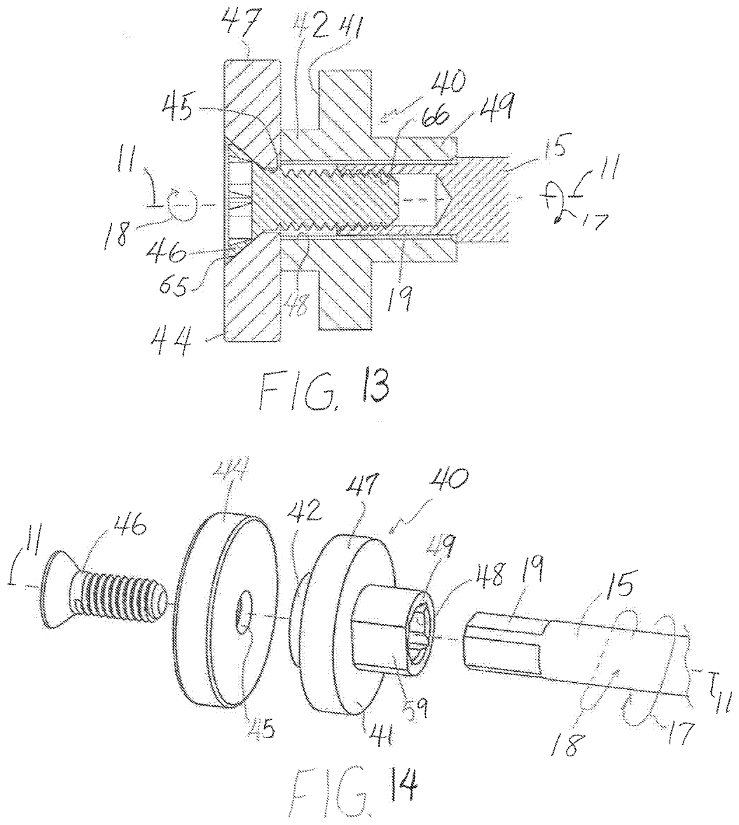

The tool holder 40 is configured to permit the insertion shaft 15 of the valve removal tool 10 to slide through the tool holder 40 along the axial direction while being non-rotatably coupled to the insertion shaft 15 of the tool 10. As shown in FIGS. 13 and 14, an embodiment of the tool holder 40 includes an annular disc that defines a central opening 48 through the tool holder 40 along the longitudinal axis 11 of rotation thereof. The distal section of the central opening 48 is configured to non-rotatably couple the insertion shaft 15 of the tool 10 to the annular disc. Thus, once the proximal end of the insertion shaft 15 of the tool is inserted through the distal section of the central opening 48 of the tool holder 40 as shown in FIG. 13 for example, then rotation of the tool holder 40 effects commensurate rotation of the insertion shaft 15 in the same direction, whether clockwise 17 or counterclockwise 18. As shown in FIG. 14 for example, a sleeve 49 extends axially from the distal side of the annular disc 41. At least a portion of the distal section of the central opening 48 defined through the tool holder 40 internally of the sleeve 49 desirably is defined by a non-cylindrical surface. As shown in FIG. 14 for example, a section 19 of the external surface of the proximal end of the insertion shaft 15 is likewise non-cylindrical and retained in the central opening 48. Any cross-sectional shape that includes a polygon will suffice to effect the non-rotatable coupling between the insertion shaft 15 of the tool and the tool holder 40. The tool holder 40 desirably is formed of strong rigid material such as steel, bronze or other metal. The tool holder 40 desirably could be formed of hard plastic material such as polycarbonate or formed of a resinous matrix of carbon fiber or fiberglass.

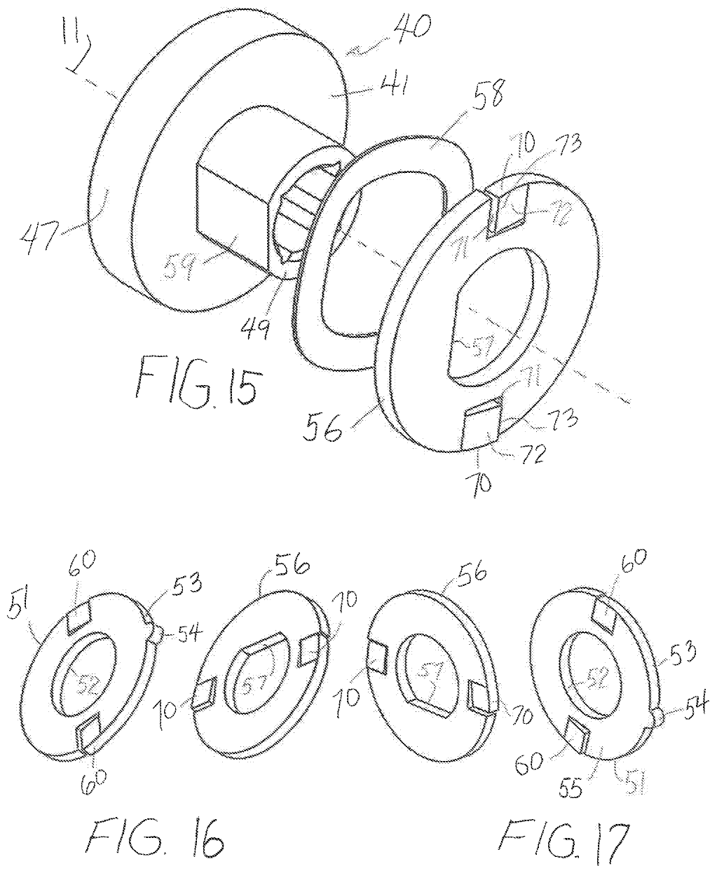

As noted above, a clutch 50 couples the tool holder 40 to the knob 30 while being configured to limit the maximum torque that can be applied to the tool holder 40 via the knob 30 in the clockwise direction 17 without limiting the torque that can be applied to the tool holder 40 via the knob 30 in the counterclockwise direction. In accordance with the present invention, as shown in FIGS. 11 and 12 for example, an alternative embodiment of a clutch 50 includes a knob plate 51. As shown in FIGS. 16, 17 and 18, an embodiment of a knob plate 51 desirably includes a ring defining a central opening 52, which is configured to permit unimpeded passage of the insertion shaft 15 of the tool 10 through the central opening 52 without any contact between the edge defining the central opening 52 and the exterior surface of the insertion shaft 15 of the tool 10. The outermost edge of the ring is configured to be retained within the passage defined by the internal surface 32 of the knob 30 and in contact with the internal surface 32 of the knob 30. As shown in FIGS. 11, 16, 17 and 12, the outermost edge 53 of the ring defines a projection 54, which extends radially away from the outermost edge 53 of the ring. The projection 54 is configured to be received and held secure in an axial groove (not shown), which is defined in the internal surface 32 of the knob 30. In an alternative embodiment, the axial groove is configured to extend axially from the proximal end of the knob 30 to the distal end of the knob 30 and recessed beneath the internal surface 32 of the knob 30. The disposition of the projection 54 into the axial groove ensures that the knob plate 51 is non-rotatably coupled to the knob 30. Thus, rotation of the knob 30 about the longitudinal axis 11 effects commensurate rotation of the knob plate 51 in the same direction about the longitudinal axis 11, whether clockwise 17 or counterclockwise 18. The knob plate 51 desirably is formed of strong rigid material such as steel, bronze or other metal. The knob plate 51 desirably could be formed of hard plastic material such as polycarbonate or formed of a resinous matrix of carbon fiber or fiberglass.

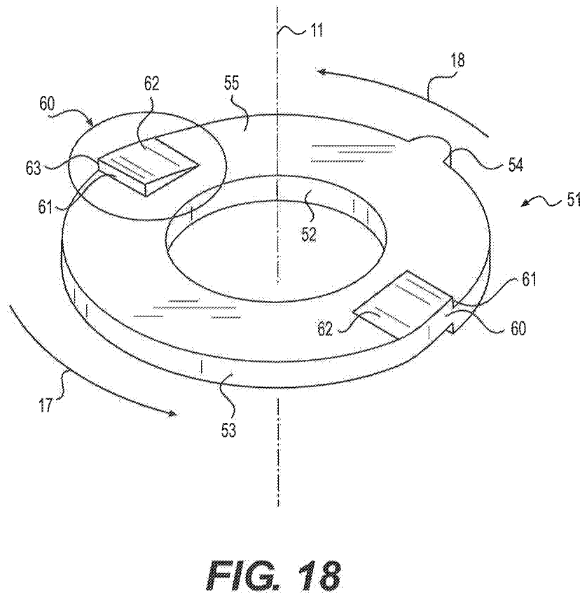

An alternative embodiment of a clutch 50 includes a holder plate 56. As shown in FIGS. 17 and 18, an embodiment of a holder plate 56 desirably includes a ring defining a central opening, which is configured to permit unimpeded passage of the insertion shaft 15 of the tool 10 through the central opening without any contact between the edge defining the central opening and the exterior surface of the insertion shaft 15 of the tool 10. The outermost edge of the ring embodying the holder plate 56 is configured to be retained within the passage of the knob 30 and in contact with the internal surface 32 of the knob 30. The holder plate 56 desirably is formed of strong rigid material such as steel, bronze or other metal. The holder plate 56 desirably could be formed of hard plastic material such as polycarbonate or formed of a resinous matrix of carbon fiber or fiberglass.

As shown in FIGS. 15, 16 and 17 for example, the central opening of the ring that forms an embodiment of a holder plate 56 is configured with a non-cylindrical surface 57. As shown in FIG. 15, for example, this non-cylindrical surface 57 of the central opening of the ring that forms an embodiment of a holder plate 56 is configured commensurately with a non-cylindrical surface 59 formed in the exterior surface of the sleeve 49 of the tool holder 40. Thus, the hand-in-glove dispositions of the non-cylindrical surface 59 of the exterior surface of the sleeve 49 of the tool holder 40 through the central opening of the holder plate 56 configured with its non-cylindrical surface 57 ensures that the holder plate 56 is non-rotatably coupled to the tool holder 40. As schematically shown in FIGS. 11 and 15 for example, rotation of the holder plate 56 about the longitudinal axis 11 effects commensurate rotation of the tool holder 40 in the same direction (clockwise 17 or counterclockwise 18) about the longitudinal axis 11.

As shown in FIG. 11, a proximal side of the knob plate 51 is disposed facing the holder plate 56. As shown in FIGS. 11, 17 and 18, a proximal surface 55 of the knob plate 51 is defined by a driving surface, which defines a proximal wedge-shaped protuberance 60. Desirably, more than one proximal wedge-shaped protuberance 60 is defined and disposed symmetrically as part of the driving surface of the proximal side of the knob plate 51. In the embodiment shown in FIG. 18, two proximal wedge-shaped protuberances 60 are defined by the driving surface of the proximal side of the knob plate 51 and disposed symmetrically 180 degrees apart from each other around the circumference of the proximal side of the knob plate 51. As shown in FIG. 18 for example, each proximal wedge-shaped protuberance includes a proximal stop surface 61 and a proximal ramp surface 62. As shown in FIG. 18, the proximal stop surface 61 is a flat planar surface that is normal to the proximal side of the knob plate 51 in a direction parallel to the longitudinal axis 11. As shown in FIG. 18, the proximal ramp surface 62 is configured so that it is gradually inclining from a lowest point to a vertex 63 of the proximal wedge-shaped protuberance 60. The proximal stop surface 61 is contiguous to the proximal ramp surface 62 at the vertex 63 of the proximal wedge-shaped protuberance 60. In the embodiment of the knob plate 51 depicted in FIGS. 16 and 17, each of the proximal wedge-shaped protuberances 60 desirably can be formed in a cutting and stamping operation applied to each of the opposite sides of the knob plate 51. In the embodiment of the knob plate 51 depicted in FIG. 18, each of the proximal wedge-shaped protuberances 60 desirably can be formed in a machining operation applied to the proximal side of the knob plate 51.

As shown in FIGS. 2 and 12, a distal side of the holder plate 56 is disposed facing the knob plate 51. The distal side of the holder plate 56 facing the knob plate 51 is the opposite side of the holder plate 56 that faces the tool holder 40 shown in FIG. 11. As shown in FIG. 15 for example, the distal side of the holder plate 56 desirably is formed as a mirror image of the proximal surface 55 of the knob plate 51 shown in FIG. 18. As shown in FIG. 15, the distal side of the holder plate 56 is defined by an engaging surface, which defines a pair of spaced apart distal wedge-shaped protuberances 70. Each of the distal wedge-shaped protuberances 70 includes a distal stop surface 71 and a distal ramp surface 72. As shown in FIG. 15, the distal stop surface 71 is a flat planar surface that is normal to the distal side of the holder plate 56. As shown in FIG. 15, the distal ramp surface 72 is configured so that it gradually inclines from a lowest point to a vertex 73 of the distal wedge-shaped protuberance 70. The distal stop surface 71 is contiguous to the distal ramp surface 72 at the vertex 73 of the distal wedge-shaped protuberance 70. Desirably, as shown in FIG. 15, two distal wedge-shaped protuberances 70 are defined by the engaging surface of the distal side of the holder plate 56 and disposed symmetrically 180 degrees apart from each other around the circumference of the distal side of the holder plate 56. The distal wedge-shaped protuberances 70 can be formed in the holder plate 56 in much the same manner as the proximal wedge-shaped protuberances 60 can be formed in the knob plate 51.

The clutch 50 desirably includes a biasing element that is configured and disposed to urge the engaging surface against the driving surface with a force that is predetermined according to a maximum torque for rotating the valve core 16 into the valve seat. As embodied herein and shown in FIGS. 10, 11, 12 and 15, a biasing element 58 desirably includes a spring disposed between the tool holder 40 and the holder plate 56 and configured to exert a biasing force in the axial direction along the central longitudinal axis 11. As embodied herein and shown in FIGS. 11 and 15, a wave spring desirably serves as a suitable biasing element 58 to exert a biasing force in the axial direction. However, the biasing element 58 can be, but is not limited to, a traditional wound spring, a Belleville spring, or an object made out of a compressible material such as an O-ring, which can be made out of a variety of different compounds and profiles to obtain the desired compressibility and spring force.

The resilient force constant (aka the spring constant) of the biasing element 58 and the distance the biasing element 58 is compressed axially in the assembly of the torque driver 20, and the resulting biasing force, will determine the threshold torque at which the knob 30 slips, i.e., rotates in the clockwise direction 17 independently of the tool holder 40. This is the threshold torque and is the design torque that is to be attained when the valve core 16 will be installed in the valve seat in a manner that ensures against leakage but without damaging the threads of either the valve seat or the valve core 16. When the magnitude of the axially directed force exerted by the biasing element 58 remains below the threshold design torque, then when the knob plate 51 rotates in the clockwise direction 17 relative to the holder plate 56 under these conditions, the proximal ramp surface 62 is disposed contacting the distal ramp surface 72 without any slippage with respect to the distal ramp surface 72. In other words, the frictional forces between the proximal ramp surface 62 and the distal ramp surface 72 suffice to prevent relative movement between the holder plate 56 and the knob plate 51 when the user exerts torque on the knob 30 of the torque driver 20 in the clockwise direction 17 as shown in FIG. 3 for example. Moreover, the axial force exerted by the biasing element 58 is always of sufficient magnitude to ensure that the proximal stop surface 61 is disposed contacting the distal stop surface 71 when the knob plate 51 rotates in the counterclockwise direction 18 schematically shown in FIGS. 3 and 11.

As shown in FIGS. 11 and 14 for example, the proximal side of the tool holder 40 includes a cylindrical collar 42 that extends axially from the proximal surface of the annular disc portion 41 of tool holder 40. The torque driver 20 desirably includes a bulkhead element 43 that resists against movement of the tool holder 40 in the axial direction toward the proximal end of the knob 30. As embodied herein and shown in FIGS. 10 and 11 for example, a bulkhead element 43 includes a snap spring. The snap spring is received and retained in a circumferentially extending groove 36 defined circumferentially in the internal surface 32 of the knob 30 near the proximal end of the knob 30 and recessed from the extreme proximal end of the knob 30. The snap spring is disposed around the collar 42 of the tool holder 40 and contacting the proximal surface of the annular disc portion 41 of the tool holder 40 so as to resist against movement of the tool holder 40 in the axial direction past the snap spring 43 toward the proximal end of the knob 30. Thus, the bulkhead element 43 absorbs any axial force resulting from the axially directed pressure that is needed in order to maintain the distal end of the insertion shaft 15 engaged with the valve core 16 for purposes of rotating the valve core 16 with respect to the valve seat.

Each of the bulkhead element 43 and the distal web 33 of the knob 30 defines a respective opposite end of a chamber within which the tool holder 40, the biasing element 58, the holder plate 56 and the knob plate 51 are constrained against movement in an axial direction outside of this constrained space that is inside the chamber. These axial constraints imposed between the bulkhead element 43 and the distal web 33 of the knob 30 permit the axially directed force applied by the biasing element 58 to determine the design torque at which the distal ramp surface 72 of the holder plate 56 slips past the proximal ramp surface 62 of the knob plate 51 when the knob 30 is rotated in the clockwise direction 17 depicted in FIGS. 3 and 11 for example to screw the valve core 16 into the valve seat of the HVAC valve.

The torque driver 20 of the present invention is configured to enable the user to apply sufficient axially directed pressure with the insertion shaft 15 of the tool 10 so as to be able to engage the valve core 16 with the insertion shaft 15 so that the torque driver 20 can be used to rotate the insertion shaft 15 and then engage the valve core 16 with respect to the valve seat of the HVAC valve. As embodied herein and shown in FIGS. 2, 10 and 11 for example, the extreme proximal end of the knob 30 defines an annular recess 37. As shown in FIG. 10, the annular recess 37 includes a shoulder 38 extending diametrically from the internal surface 32 of the knob 30 toward the central axis 11 of the knob 30. The shoulder 38 is disposed spaced apart in the axial direction from the proximal edge of the knob 30 internally toward the distal web 33 of the knob 30.

The annular recess 37 defined in the proximal end of the knob 30 is configured to receive therein a cap 44, which as shown in FIGS. 2, 10 and 11 is formed as a disk. So that the cap 44 does not project beyond the proximal edge of the knob 30, the thickness of the cap 44 in the axial direction desirably is commensurate with the axial length of the annular recess 37 from the proximal edge of the knob 30 to the shoulder 38. As schematically shown in FIG. 11, the cap 44 defines a channel 45 through the center thereof. As shown in FIG. 13, the proximal portion 65 of the channel 45 is countersunk and so configured to receive and support the head of an attachment screw 46 that elongates axially via an externally threaded shaft extending from the head of the screw 46. The distal portion of the channel 45 has a smaller diameter than the proximal portion and is configured to allow the threaded shaft of the attachment screw 46 to pass unimpeded through the channel 45 defined through the cap 44.

As schematically shown in FIG. 13, the proximal end of the insertion shaft 15 is configured with a bore 66 that is internally threaded to mate with the external threads of the attachment screw 46. Once the attachment screw 46 is passed through the channel 45 defined through the cap 44 and screwed into the bore 66 in the proximal end of the insertion shaft 15, then the insertion shaft 15 becomes connected to the knob 30 such that axial movement of the knob 30 produces a commensurate axial movement of the insertion shaft 15.

In operation, as schematically shown in FIG. 11, the user begins assembling the torque driver 20 by aligning the projection 54 of the knob plate 51 with the axial groove (not shown) extending axially along the internal surface 32 of the knob 30 and then sliding the knob plate 51 into the chamber within the knob 30 until the distal side of the knob plate 51 rests against the distal web 33 of the knob 30. The user then positions the biasing element 58 against the distal surface of the annular disc 41 of the tool holder 40. The user then aligns the non-cylindrical surface 59 of the sleeve 49 of the tool holder 40 with the non-cylindrical surface 57 of the central opening of the holder plate 56 before sliding the sleeve 49 through the central opening of the holder plate 56 so that the biasing element 58 becomes sandwiched between the holder plate 56 and the tool holder 40 as shown in FIG. 4 for example. This sub-assembly of the holder plate 56, the biasing element 58 and the tool holder 40 is inserted axially into the chamber within the knob 30 as schematically shown in FIG. 11 until the distal surface of the holder plate 56 contacts the proximal surface 55 of the knob plate 51 as schematically shown in FIG. 10. Then, as schematically shown in FIG. 10, the user inserts the bulkhead element 43 into the circumferentially extending groove 36 defined in the internal surface 32 of the knob 30 to secure the tool holder 40, the biasing element 58, the holder plate 56 and the knob plate 51 within the chamber internally of the knob 30. The bulkhead element 43 in the illustrated embodiment is diametrically flexible so that it can be selectively inserted into the circumferential groove 36 or extracted from the circumferential groove 36 as the user desires.

Once the bulkhead element 43 is fixed in place as schematically shown in FIG. 10, then the torque driver 20 is ready to be attached to the insertion tool. As shown schematically for example in FIG. 2, the insertion shaft 15 already will have been threaded through the valve removal apparatus 10 with the proximal end of the insertion shaft 15 projecting out of the pressure fitting 13 and the distal end of the insertion shaft 15 with the gripper 25 (valve core 16 not shown) extending out of the coupling fitting 14. As schematically shown in FIG. 12, the user inserts the proximal end section 19 of the insertion shaft 15 through the aperture 34 through distal web 33. As schematically shown in FIGS. 13 and 14, the user rotates the insertion shaft 15 about its central axis 11 until the proximal end section 19 of the insertion shaft 15 is aligned to be slid into the central opening 48 defined internally of the sleeve 49 on the distal side of the annular disc 41 of the tool holder 40. Once the proximal end section 19 of the insertion shaft 15 is received within the central opening 48 defined internally of the sleeve 49, then the tool holder 40 has become non-rotatably coupled to the insertion shaft 15. As schematically shown in FIG. 13, the user then passes the screw 46 through the channel 45 of the cap 44 anti; the head of the screw 46 rests against the countersunk proximal portion 65 of the channel 45 and then screws the screw 46 into the bore 66 of the insertion shaft 15 until the cap 44 rests against the shoulder 38 of the knob 30 to connect the cap 44 to the tool holder 40 and connect the tool holder 40 to the proximal end section 19 of the insertion shaft 15. Accordingly, the torque driver 20 has become non-rotatably connected to the insertion shaft 15 of the valve removal apparatus 10. The user then attaches a valve core 16 onto the gripper 25 at the distal end of the insertion shaft 15 of the insertion tool as shown schematically in FIG. 3 for example. The valve removal apparatus 10 is then outfitted to install a replacement valve core 16 into the valve seat of an HVAC valve (not shown).

The user attaches the coupling fitting 14 to the proximal end of the HVAC valve (not shown). Once the valve core 16 reaches the valve seat (not shown); then the users rotation of the torque driver 20 in the clockwise direction 17 about the longitudinal axis 11 is effected by clockwise rotation of the knob 30. This rotation of the knob 30 in the clockwise direction 17 effects a commensurate clockwise rotation of the insertion shaft 15 of the insertion tool and accordingly effects a clockwise rotation of the valve core 16. This clockwise rotation of the valve core 16 screws the valve core 16 into the valve seat.

However, once the design torque between the valve core 16 and the valve seat has been attained, then the operation of the clutch 50 prevents any further rotation of the knob 30 from further rotating the insertion shaft 15 and the attached valve core 16. The torque driver 20 can be provided with different design torques by the mere substitution of different biasing elements 58 having different resilient force constants that are attuned to the desired maximum design torque that is appropriate to the valve core 16 and valve seat in question. This substitution is easily performed by merely unscrewing the screw 46 from the proximal end of the insertion shaft 15, removing the cap 44 and the bulkhead element 43 and sliding the tool holder 40 axially out of the proximal end of the knob 30. Then the biasing element 58 can be removed and replaced.

Removal of a valve core 16 means that the coupling fitting 14 of the valve removal apparatus 10 is connected to the proximal end of the HVAC valve (not shown) when the distal end of the insertion shaft 15 with the gripper 25 is extending out of the coupling fitting 14 without any valve core 16 connected to the gripper 25. The user moves the knob 30 axially until the gripper 25 non-rotatably secures the valve core 16. The user than rotates the knob 30 and the insertion shaft 15 and valve core 16 in the counterclockwise direction 18 to unscrew the valve core 16 from the valve seat of the HVAC valve. However, in accordance with the torque driver 20 of the present invention, the clutch 50 is not operative during rotation of the knob 30 in the counterclockwise direction 18, and thus the torque driver 20 of the present invention can be used to remove a valve core 16 by rotation of the knob 30 in the counterclockwise direction 18 even if the torque required for removal exceeds the design torque of the clutch 50.

What is claimed is:

1. A torque driver for driving a tool for selectively installing and removing a valve core from a valve seat of a valve in a pressurized system, the torque driver comprising:
a knob defining a proximal end and a distal end spaced apart in an axial direction from the proximal end, the knob defining an entrance opening at the distal end, the knob defining an internal surface extending from the entrance opening at the distal end toward the proximal end, wherein the internal surface defines a passage that is generally cylindrically shaped about a central longitudinal axis that elongates along the axial direction;
a tool holder defining a proximal end and a distal end spaced apart in the axial direction from the proximal end, the tool holder being disposed within the passage and rotatable about the central axis with respect to the internal surface of the knob, the proximal end of the tool holder being disposed at the proximal end of the knob, the tool holder defining a recess opening through the distal end of the tool holder, the tool holder defining a tool recess extending from the recess opening toward the proximal end of the tool holder and configured to slidably receive therein a section of the tool; and
a clutch that couples the tool holder to the knob, wherein the clutch is configured to limit the torque between the tool holder and the knob in a first rotational direction without limiting the torque between the tool holder and the knob in a second rotational direction that is opposite to the first rotational direction.

2. The torque driver of claim 1, wherein the tool holder includes a cylindrical body that elongates about the central longitudinal axis in the axial direction between the proximal end and the distal end, the tool recess extending in the axial direction about the central longitudinal axis.

3. The torque driver of claim 2, wherein the tool holder defines a pin passage that extends in a transverse direction that is normal to the axial direction and that elongates sufficiently to pass through the tool recess.

4. The torque driver of claim 1, wherein the tool holder defines a clutch passage that extends through the cylindrical body in a transverse direction that is normal to the axial direction.

5. The torque driver of claim 1, wherein the clutch includes a first detent button, a second detent button and a spring disposed between the first detent button and the second detent button.

6. The torque driver of claim 5, wherein the first detent button, the second detent button and the spring are disposed in the clutch passage.

7. The torque driver of claim 5, wherein each of the first detent button and the second detent button engages the internal surface of the knob.

8. The torque driver of claim 1, wherein:
the internal surface of the knob defines a first engaging surface that includes a first wedge-shaped protuberance, wherein the first wedge-shaped protuberance includes a first distal stop surface and a first ramp surface, wherein the first stop surface is a flat planar surface and the first ramp surface is gradually inclining from a lowest point to a vertex, wherein the first stop surface is contiguous to the first ramp surface at the vertex of the first ramp surface.

9. The torque driver of claim 8, wherein the clutch includes a first detent button, a second detent button and a spring disposed between the first detent button and the second detent button, wherein the first ramp surface is disposed contacting one of the first detent button and the second detent button when the knob rotates in the first rotational direction about the central longitudinal axis, and wherein the first stop surface is disposed to contact one of the first detent button and the second detent button when the knob plate rotates in the second rotational direction about the central longitudinal axis.

10. The torque driver of claim 8, wherein the internal surface of the knob defines a second engaging surface that includes a second wedge-shaped protuberance, wherein the second wedge-shaped protuberance includes a second stop surface and a second ramp surface, wherein the second stop surface is a flat planar surface and the second ramp surface is gradually inclining from a lowest point to a vertex, wherein the second stop surface is contiguous to the second ramp surface at the vertex of the second ramp surface.

11. The torque driver of claim 1, further comprising a bulkhead element that includes a ring, wherein the internal surface of the knob defines an inner slot that extends circumferentially about the central longitudinal axis, wherein the tool holder defines an outer slot that extends circumferentially about the central longitudinal axis and disposed opposite the inner slot, wherein the ring is received in both the inner slot and the outer slot and configured to restrain movement of the tool holder in the axial direction relative to the knob along the central longitudinal axis.

12. The torque driver of claim 1, further comprising a sealing element that includes a resiliently deformable O-ring, wherein the internal surface of the knob defines an inner groove that extends circumferentially about the central longitudinal axis, wherein the tool holder defines an outer groove that extends circumferentially about the central longitudinal axis and disposed opposite the inner groove, wherein the O-ring is received in both the inner groove and the outer groove and configured to seal the passage of the knob.

13. An apparatus for selectively installing and removing a valve core from a valve installed in a pressurized system, the apparatus comprising:
a tool for selectively installing and removing a valve core from a valve installed in a pressurized system, the tool defining a rod extending in an axial direction between a proximal end and a distal end; and
a torque driver;
wherein the torque driver includes:
a knob defining a proximal end and a distal end spaced apart in an axial direction from the proximal end, the knob defining an entrance opening at the distal end, the knob defining an internal surface extending from the entrance opening at the distal end toward the proximal end, wherein the internal surface defines a passage that is generally cylindrically shaped about a central longitudinal axis that elongates along the axial direction;
a tool holder defining a proximal end and a distal end spaced apart in the axial direction from the proximal end; the tool holder being disposed within the passage and rotatable about the central axis with respect to the internal surface of the knob, the proximal end of the tool holder being disposed at the proximal end of the knob, the tool holder defining a recess opening through the distal end of the tool holder, the tool holder defining a tool recess extending from the recess opening toward the proximal end of the tool holder and configured to slidably receive therein a section of the tool; and
a clutch that couples the tool holder to the knob, wherein the clutch is configured to limit the torque between the tool holder and the knob in a first rotational direction without limiting the torque between the tool holder and the knob in a second rotational direction that is opposite to the first rotational direction.

14. The apparatus of claim 13, further comprising a pin connecting the proximal end of the rod and the tool holder.

15. The apparatus of claim 14, wherein the proximal end of the rod defines a side bore that extends through the proximal end of the rod in a transverse direction that is normal to the axial direction of the rod; wherein the tool holder includes a cylindrical body that elongates about the central longitudinal axis in the axial direction between the proximal end and the distal end, the tool recess extending in the axial direction about the central longitudinal axis; wherein the tool holder defines a pin passage that extends in the transverse direction and that elongates sufficiently to pass through the tool recess; and wherein the pin is received in the pin passage of the tool holder and the side bore of the proximal end of the rod.

16. The apparatus of claim 13, wherein the tool holder defines a clutch passage that extends through the cylindrical body in a transverse direction that is normal to the axial direction.

17. The apparatus of claim 13, wherein the clutch includes a first detent button, a second detent button and a spring disposed between the first detent button and the second detent button, wherein each of the first detent button and the second detent button engages the internal surface of the knob.

18. The apparatus of claim 13, wherein the internal surface of the knob defines a first engaging surface that includes a first wedge-shaped protuberance, wherein the first wedge-shaped protuberance includes a first stop surface and a first ramp surface, wherein the first stop surface is a flat planar surface and the first ramp surface is gradually inclining from a lowest point to a vertex, wherein the first stop surface is contiguous to the first ramp surface at the vertex of the first ramp surface.

19. The apparatus of claim 18, wherein the clutch includes a first detent button, a second detent button and a spring disposed between the first detent button and the second detent button, wherein the first ramp surface is disposed contacting one of the first detent button and the second detent button when the knob rotates in the first rotational direction about the central longitudinal axis, and wherein the first stop surface is disposed to contact one of the first detent button and the second detent button when the knob plate rotates in the second rotational direction about the central longitudinal axis.

20. The torque driver of claim 18, wherein the internal surface of the knob defines a second engaging surface that includes a second wedge-shaped protuberance, wherein the second wedge-shaped protuberance includes a second stop surface and a second ramp surface, wherein the second stop surface is a flat planar surface and the second ramp surface is gradually inclining from a lowest point to a vertex, wherein the second stop surface is contiguous to the second ramp surface at the vertex of the second ramp surface.
